(19) United States
(12) Patent Application Publication
(10) Pub. No.: US 2004/0256132 A1
(43) Pub. Date: Dec. 23, 2004

(54) Housing made of fire-inhibiting material

(76) Inventor: Boris Schubert, Rodgau (DE)

Correspondence Address: BURNS DOANE SWECKER & MATHIS L L P, POST OFFICE BOX 1404, ALEXANDRIA, VA, 22313-1404, US

(21) Appl. No.: 10/490,895

(22) PCT Filed: Nov. 14, 2002
(86) PCT No.: PCT/DE02/04210

(30) Foreign Application Priority Data
Nov. 27, 2001 (DE) 101 58 040.1
Nov. 27, 2001 (DE) 101 58 042.8

(51) Int. Cl. H02G 3/08

(52) U.S. Cl. 174/50

(57) ABSTRACT

A housing, such as an electronic distribution box, is made of fire-inhibiting material. The housing includes one back wall, two side walls, one top wall, and one bottom wall as well as one door. The side walls, the top wall and the bottom wall are provided with an inner water-containing layer and an outer fiber-containing layer. In case of fire, the water vaporizes and penetrates into the fiber-containing layer to control the maximum temperature that the two layers can reach.

The invention relates to a housing made of fire-inhibiting material comprising a back wall, two side walls, one top wall, and one bottom wall as well as one removable or rotatably mounted door.

A housing of this type is disclosed in DE 199 02 971 C1 being a distribution box to receive electronic switching devices. The interior of the distribution box is provided with a fire-protective lining. A cutout is provided in the distribution box for the insertion of cables whereby said cutout is covered by means of a cable guide cap projecting at the outside of the corresponding side wall.

Distribution boxes of this type should hold up in case of fire to the thereby occurring temperatures over a period of 30 to 90 minutes and should protect the electric devices disposed in the housing. In particular, electric power supply should be maintained for emergency lighting, for fire alarm systems, control systems, sprinkler systems and elevators.

The invention is based on the object to provide an improved housing.

This object is achieved according to the characteristics of claim 1. According to the invention, the wall is provided with an inner water-containing layer and an outer fiber-containing layer arranged in front thereof. Temperatures of 1,000° C. to 1,200° C. and even higher are reached in case of fire. The heat penetrates the housing and increases the temperature within the water-containing plate up to 100° C. The water vaporizes and penetrates into the fiber-containing layer disposed in front of said plate. Since water vapor has a constant temperature of 100° C. at atmospheric pressure, the water-containing layer as well as the outer fiber layer disposed in front of it, are heated to not more than 100° C. The distribution box heated to 100° C. is considered to be cooled compared to the temperatures at the seat of the fire of 1,000° C. and above. This means that the inner space of the distribution box is also not higher than 100° C. Electric devices operate at 100° C. without difficulties. The vaporizing time, and thereby the penetration of heat, is determined by the amount of water in the water-containing layer. The amount of water in this layer determines thus the resistance of the distribution box and the time until failure of the electronics arranged therein. The fiber layer acts as an insulation layer and the fiber material is rock wool fiber with a metal oxide component, particularly an aluminum oxide component with a high melting point, which is therefore fire-inhibiting.

The inner fiber-containing layer has advantageously a higher density that the outer fiber-containing layer. It is thereby ensured that the water vapor from the water-containing layer penetrates into the outer fiber layer and lowers the temperature to 100° C. therein.

The layer is provided with plates in a simple manner. Simple construction of the individual water- and fiber-containing layers is thereby guaranteed.

The layer is designed in the form of a mat and is flexible thereby.

The mat extends in an advantageous manner around the inner circumference of the two side walls, the top wall, and the bottom wall. The flexible mat covers thereby the plates of the walls and hold them together. The mat shrinks upon exposure to heat, compresses the housing, and seals thereby small leakages and/or manufacturing tolerances.

The mat is secured in an advantageous manner by a wire. The wire along the circumference of the walls of the distribution box and penetrates the bottom wall, the top wall, and both side walls. The wire is wrapped around the mat. The mat becomes brittle in case of fire. The wire engages the mat over a large surface, encompasses it over a large area and hold the entire structure together.

The water containing plates are simply gypsum plates. They are fire-inhibiting, easily to be manufactured, and easy to work with and to form them in a desired shape.

The outer housing layer is advantageously made of gypsum boards. Gypsum board is very strong and it can be fastened with screws onto the remaining plates of the housing in a simple manner. The screws connect the outer gypsum boards to one another so that no thermal bridge projects into the interior of the housing. A laminated plate can be provided with a variety of laminates for decorative purposes.

One screw of the door is advantageously covered with a fiber layer so that a thermal bridge projecting into the housing is interrupted.

The water-containing layer is spaced apart from an outer water-containing layer of a neighboring wall that is arranged vertical to the first wall. It is ensured thereby that conduction of heat is interrupted in case of fire and that heat is not transferred directly from the outer layer of the second wall to the water-containing plate. The created gap is filled with a layer of fiber.

A cable inlet is advantageously embedded in the wall so that the cable inlet fits flush relative to the remaining housing parts.

The housing is used in an advantageous manner as a distribution box to receive electronic switching devices and as a housing for storage and safekeeping of files and data material.

The distribution boxes are placed into furnaces to test their functioning in case of fire and under the influence of heat with temperatures above 1,000° C. The housings withstand these temperatures also for the required time of 30 to 90 minutes. However, ignored is thereby that the distribution boxes are already equipped with electronic components in operating condition. The electronic components disposed inside the housing cause the temperature to increase to values that lie clearly above the ambient temperature.

The invention has therefore the object to find a remedy in this regard and to provide a simple housing containing operating electronic components that can withstand exposure to heat over a time span longer than 90 minutes. A supply of electric power is to be guaranteed for this time span.

This object is achieved according to the characteristics of claim 1. An air duct is arranged in one wall according to the invention. The air duct serves for ventilation to lower the temperatures inside the housing to the ambient temperature during operation of the electronic components. It is already considered thereby that distribution boxes are ventilated by gaps around the doors, which are the result of manufacturing tolerances. This ventilation through gaps in doors is too little by itself to sufficiently cool the electronic components in operation. However, the ventilation duct in conjunction with the gaps reach a ventilation capacity that lowers the temperature inside the distribution box to the ambient temperature during operation of electronic components. With the ventilation duct arranged in the top wall, it is taken into consideration that heated air rises to the top.

The ventilation duct is advantageously provided with a shut-off device. This shut-off device is capable of closing the ventilation duct rapidly and securely. Known are shut-off devices comprising a metal tube, a center rod, two semicircular butterfly flaps, a spring, and a solder bead. At surpassing a defined ambient temperature of 72° C., for example, the integrated solder bead releases the flaps, which perform a quarter rotation about the center rod through the force of the spring, and close the metal tube thereby. These shut-off devices are inserted in ducts of air condition systems. It is insignificant in this case that the metal tube represents a thermal bridge.

The shut-off device ends at the inner side of the wall in an advantageous manner. A direct thermal bridge between the surroundings and the inner space of the distribution box is thereby avoided.

The ventilation duct is advantageously provided with expansion substances. These expansion substances expand in case of fire and form an insulation layer.

The ventilation duct is advantageously provided with a filter. The cleanliness of the interior is guaranteed thereby in spite of convection.

The ventilation duct is advantageously provided with a cooling fan. Forced ventilation is achieved thereby.

The cooling fan advantageously draws air through the ventilation duct. It is ensured thereby that the air transported into the inner space is cleaned by the filter whereby the gaps around the door stay clean as well.

A second ventilation duct is advantageously arranged in the door. The operating electronic components heat up the air. The air flows through the ventilation duct of the door into the interior of the distribution box and continues through the ventilation duct of the top wall into the atmosphere. Heat is thereby dissipated.

The ventilation duct is advantageously provided with an upper section and a lower section. The lower section is provided with conduits and has thereby a smaller cross section. The flow-through volume is thereby decreased and it can be rapidly closed by expansion substances.

In the following, an embodiment example is explained in more detail with the aid of the drawings for better understanding.

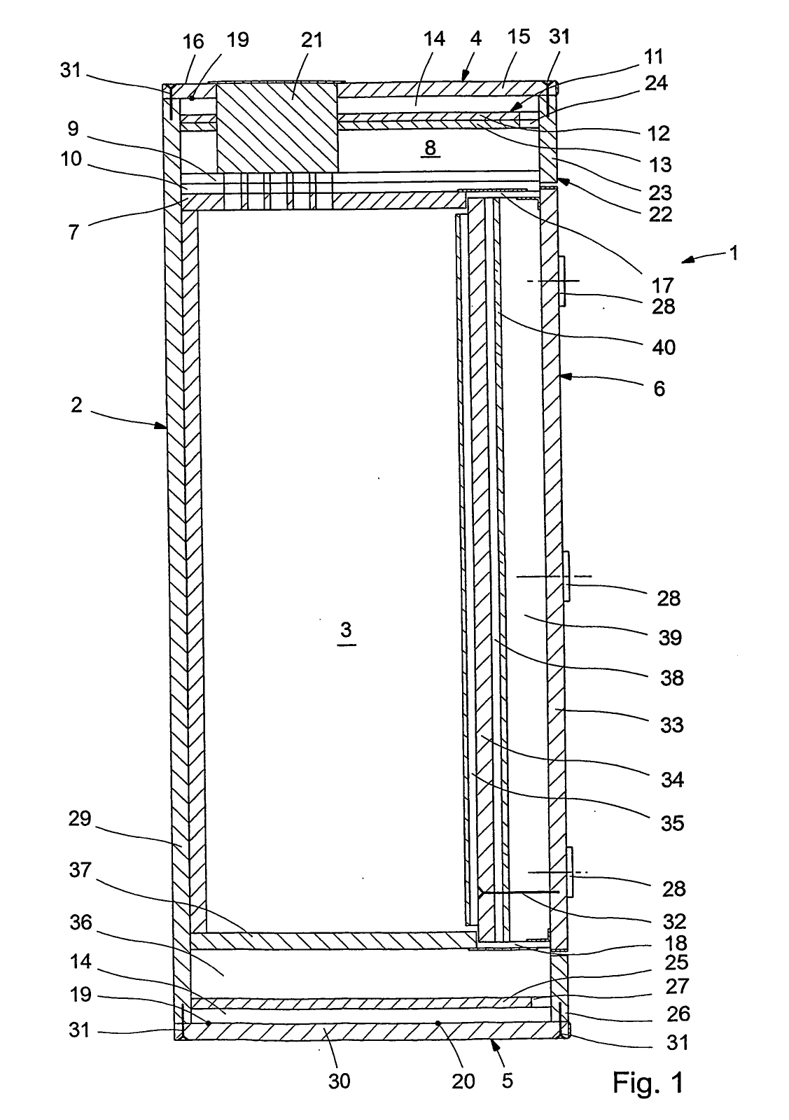

FIG. 1 shows a distribution box in a sectional side view,

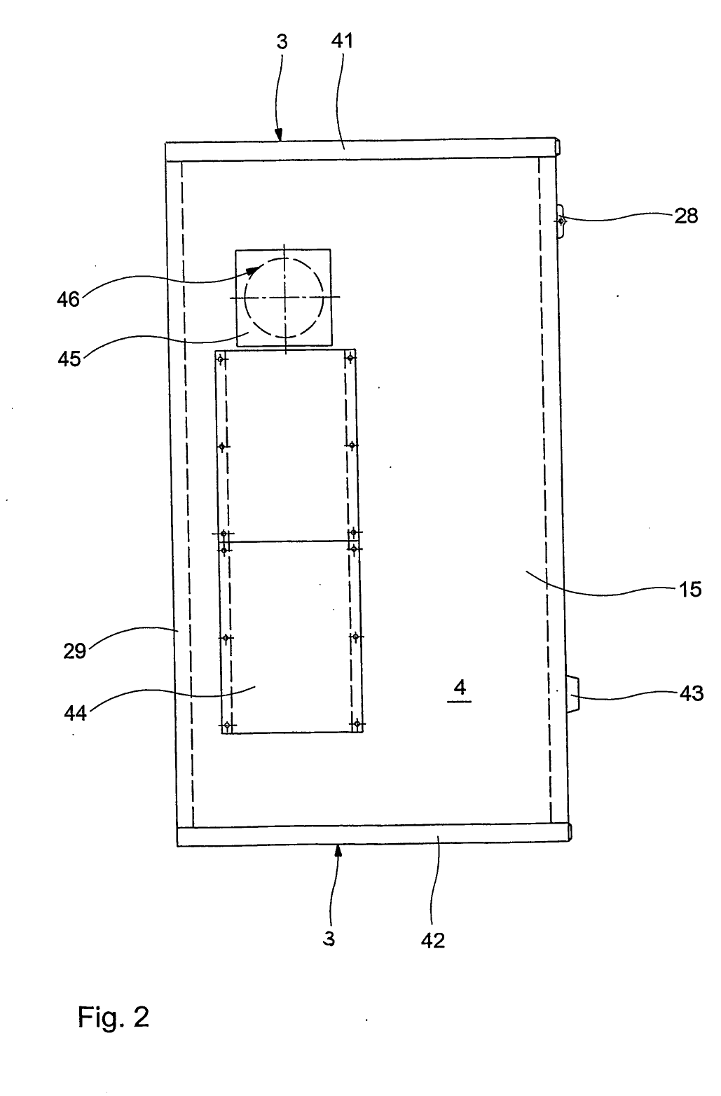

FIG. 2 shows the distribution box in a top view, and

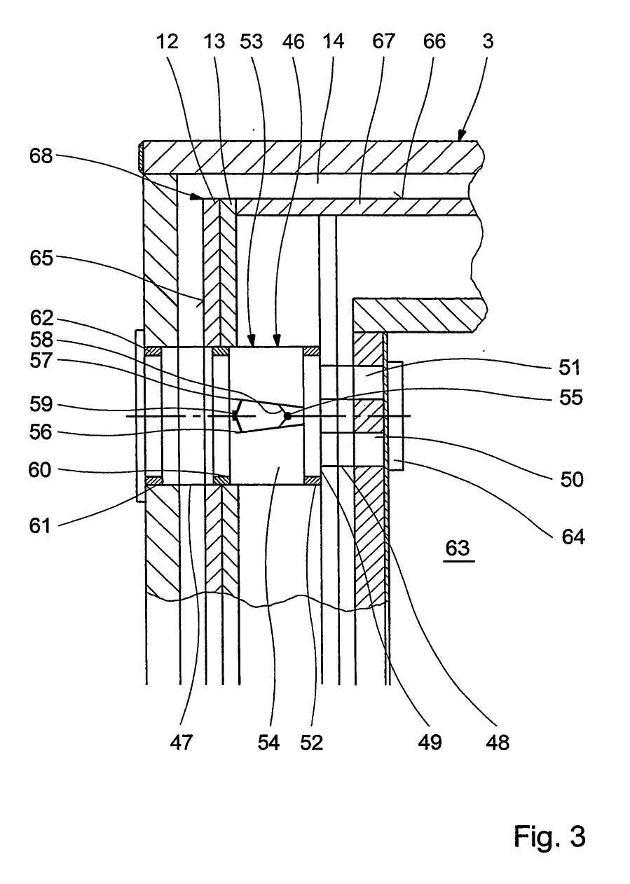

FIG. 3 shows a ventilation duct of the distribution box.

FIG. 1 shows a distribution box 1 comprising one back wall 2, two side walls 3, one top wall 4, one bottom wall 5, and one door 6. The top wall 4 is provided with a water-containing layer 7 as viewed from the inside toward the outside, then follows a fiber-containing layer 8 with plates 9 and 10, and subsequently there is a water-containing layer 11 with plates 12 and 13, and following that is a fiber layer 14 and an outer water-containing layer 15 with a lamination 16. The outer water-containing layer 15 of the distribution box 1 is formed by gypsum boards reinforced with wood fiber or partially with glass fiber. The outer fiber layer 14 has a lower density than the inner fiber layer 8. The fiber layer 14 is a fiber mat that extends along the inner circumference of the two side walls 3, the top wall 4, and the bottom wall 5. The closed door 6 is embedded between the top wall 4 and the bottom wall 5. Walls 4 and 5 define the closed door 6. Gaps 17 and 18 are provided between the walls 4 and 5 and between the door 6.

The fiber mat 14, which extends in one piece along the side wall 3, the top wall 4 and the bottom wall 5, is wrapped by wires 19 and 20, which extend thereby also along the inner circumference of the distribution box 1 and which effect large areas of the mat 14. In case of fire, the entire housing is thereby held together by the mat 14 and the wires 19 and 20. An inner plate 7 of the water-containing layer 7 made of gypsum gives the distribution box 1 inner stability and seals the inner space against the fiber material of layer 8. A cable inlet 21 is embedded in the top wall 4. An outer gypsum board 23 of the wall 4 arranged on the face 22 is oriented perpendicular to the plates 12, 13, 14, 15, and parallel to the door 6 and defines the wall 4. The gypsum boards 12 and 13 are spaced apart from the gypsum board 23 arranged at the door side 22. A thereby created gap 24 is filled with fiber material. The bottom wall 5 is also provided with a gap 27 between an inner gypsum board 25 and an additional outer gypsum board 26 oriented at the face 22 perpendicular to the first gypsum board whereby said gap 27 is filled with fiber material and ensures thereby a space between the gypsum board 25 and 26. The fiber material consists of a bio-soluble rock wool fiber with an oxide component, specifically Na₂O; K₂O; CaO; MgO; BaO; Al₂O₃; SiO₂; ZrO₂. The metal oxide component determines a high melting point of 1,050 to 1,200° C. The door 6 is rotatably mounted by means of hinges 28.

The back wall 2 is provided with an outer gypsum board 29 and the bottom wall 5 is provided with an outer gypsum board 30. The outer gypsum boards 15, 23, 26, 29 and 30 are screwed onto each other by means of screws 31, which ensure thereby stability of the distribution box 1. The screws 31 are arranged in such a manner that no thermal bridge can lead into the interior of the housing 1. One screw 32 connects an outer gypsum board 33 with and inner gypsum board 34 of the door 6. The head of said screw 32 is covered with a fiber layer 35 so that heat cannot reach the interior of the housing 1 via said screw 32 acting as a thermal bridge. The bottom wall 5 is provided with an additional fiber layer 36 being disposed behind the gypsum board 25 and there is an inner gypsum board 37 behind said fiber layer 36. The inner fiber layer 36, consisting of plates, has a higher density than the outer fiber layer 14. The door 6 is provided a fiber layer 38 at its rear having the same density as the outer fiber layer 39. The two fiber layers 38 and 39 are designed in the form of plates and are separated from each other by means of a gypsum board 40.

FIG. 2 shows the distribution box 1 comprising the gypsum boards 41, 42 of the side walls 3 and 4, the outer gypsum board 15 of the top wall 4, the hinges 28 of the door 6, a door handle 43, and the rear outer gypsum board 29 of the back wall 2. A cover 44 is arranged on the top wall 4 under which there lies the cable inlet 21. A filter 45 is arranged adjacent to the cover 44 and a ventilation duct 46 lies under said filter 45.

FIG. 3 shows the ventilation duct 46 inside the housing 1. The ventilation duct 46 is constructed in two parts, having an upper section 47 and a lower section 48. The two sections 47 and 48 are separated by a step element 49 whereby the lower section 48 is provided with conduits 50 and 51. An expansion ring 52 is placed on the step element 49. A shut-off device 53 is disposed above the expansion ring 52 whereby said shut-off device 53 comprises a metal tube 54, a center rod 55, two semicircular butterfly flaps 56 and 57, one spring 58, and a solder bead 59. The integrated solder bead 59 releases the flaps 56 and 57 after a defined ambient temperature of 72° C. has been surpassed whereby said flaps 56 and 57 perform a quarter rotation about the center rod 55 through the force of the spring 58 and said flaps instantly close the metal tube 54. An expansion ring 60 is arranged on the metal tube 54 and a third expansion ring 62 is arranged on the upper end 61 of the ventilation duct 46. The expansion substances 52, 60 and 62 expand through the effects of heat in case of fire, close the ventilation duct 46, and prevent forming of a thermal bridge created by the metal tube 54 into the inner space 63 of the distribution box 1. A fan 64, also called a cooling fan in the following text, is arranged in the inner space 63 below the conduits 50 and 51. The fiber mat 14 extends across the surfaces 65 and 66 of the plate 12, across an additional gypsum board 67 of the wall 3, and across the corner 68 formed by the plate 12 inside the wall 3.

1-24. (canceled)

25. A fire-resistant housing comprising one back wall, two side walls, one top wall, and one bottom wall as well as a door, characterized in that at least one of the side walls, the top wall, and the bottom wall being provided with an inner water-containing layer and an outer fiber-containing layer arranged in front of said water-containing layer.

26. A housing according to claim 25, wherein a second inner fiber-containing layer is arranged behind the water-containing layer.

27. A housing according to claim 25, wherein the inner fiber-containing layer has a higher density than the outer fiber-containing layer.

28. A housing according to claim 25, wherein the fiber-containing layer comprises a plate.

29. A housing according to claim 25, wherein the outer fiber-containing layer comprises a mat.

30. A housing according to claim 29, wherein said mat extends across an inner circumference of the two side walls, the top wall, and the bottom wall.

31. A housing according to claim 25, wherein said mat is secured by a wire.

32. A housing according to claim 25, wherein the water-containing plates comprise gypsum boards.

33. A housing according to claim 25, wherein an outermost layer of the housing is formed by gypsum board.

34. A housing according to claim 33 wherein each gypsum board is held in place by at least one screw.

35. A housing according to claim 34 wherein a screw holding a gypsum board of the door is covered by a fiber layer.

36. A housing according to claim 25, wherein the water-containing layer is spaced apart from an outer housing layer that is arranged perpendicular to the water-containing layer.

37. A housing according to claim 25 wherein a cable inlet is embedded in the top wall.

38. A housing according to claim 25 wherein the housing contains electronic switching.

39. A fire-resistant housing comprising one back wall, two side walls, one top wall, and one bottom wall as well as characterized in that a ventilation duct is arranged in the top wall.

40. A housing according to claim 39 wherein said ventilation duct is provided with a shut-off device.

41. A housing according to claim 40 wherein said shut-off device ends inside the top wall.

42. A housing according to claim 39 wherein said ventilation duct is provided with expansion substances.

43. A housing according to claim 39 wherein said ventilation duct is provided with a filter.

44. A housing according to claim 39 wherein said ventilation duct is provided with a cooling fan.

45. A housing according to claim 44 wherein said cooling fan is arranged to draw air through said ventilation duct.

46. A housing according to claim 39 wherein a second ventilation duct is arranged in said door.

47. A housing according to claim 39 wherein said ventilation duct is provided with an upper section and a lower section.

48. A housing according to claim 25 wherein the at least one wall comprises the side walls, the top wall, and the bottom wall.
